(19) United States
(12) Patent Application Publication
(10) Pub. No.: US 2014/0194061 A1
(43) Pub. Date: Jul. 10, 2014

(54) DEVICE FOR COMMUNICATING THROUGH THE BODY, CUSTOMISABLE WITH AN ACCESSORY

(71) Applicant: Jean-Yves Fine, Marseille (FR)

(72) Inventor: Jean-Yves Fine, Marseille (FR)

(73) Assignee: GEMALTO SA, Meudon (FR)

(21) Appl. No.: 14/239,161

(22) PCT Filed: Aug. 10, 2012
(86) PCT No.: PCT/EP2012/065762

§ 371 Date: Feb. 17, 2014

(30) Foreign Application Priority Data
Aug. 18, 2011 (EP) 11306055.2

(51) Int. Cl. H04B 5/00

(52) U.S. Cl. CPC H04B 5/0031
USPC 455/41.1

(57) ABSTRACT

The invention concerns a portable electronic device having a module for communicating through the body, the module including a contact surface for electrical contact with the skin of a wearer, a base containing the module, a mechanism for securing the device to a part of the body of the wearer, in contact with the skin, and structure for attaching a personal accessory or a watch case to the device. The device differs in that it comprises structure for attaching a personal accessory or a watch case arranged on the base or on the securing mechanism.

### FIELD OF THE INVENTION

The present invention relates to systems for identifying an individual during an electronic transaction.

More specifically, the invention relates to digital identification personal devices for communicating through the body, such as the eGo type device described in Patent No EP 1695296 B1 or on the http://ego-project.eu/site.

### STATE OF THE ART

The applicant's patent EP 1695296 B1 describes the principle of a communication through the body wherein a prior authentication of the user is provided by means of a fingerprint.

The invention aims to allow anyone (having a watch or any other object) to carry a personal digital identification device in a discreet and elegant way.

In particular, a need arises for a unit device (without a new object or accessory) able to detect the unfastening of the device from a user's body.

Alternately, a need also exists for movement detection capabilities integrated in the device for making a digital signature in an easy and aesthetic way with required safety.

### SUMMARIZED CHARACTERISTICS OF THE INVENTION

The principle of the invention is to adapt any watch case or any other accessory on a device having a system for fastening to the body and more particularly a strap, comprising a module for communicating through the body. Thus, the device for communicating through the body is hidden by the aesthetic design of the watch or of the accessory. Preferably, the accessory is removable from the communication module in particular to be used with or without the accessory or the watch.

For this purpose, the invention relates to a portable electronic device comprising a module for communicating through the body (of the “eGo” type), with said module comprising a contact surface for electrically contacting the skin of a wearer,
a base comprising said module,
means for securing the device to a part of the body of the wearer, in contact with the skin
means for attaching a personal accessory or a watch case on the device.

According to other characteristics:
the securing means comprise a strap including watch case fasteners arranged over the strap;
the base comprises a housing for receiving the communication module; the receiving housing is so configured as to removeably receive the module;
the device comprises means for detecting the securing on and the separation from the wearer based on capacitive plates;
the device is so configured as to perform a transaction or a validation after authentication of the wearer and securing thereto within a predetermined time and/or before detecting a separation therefrom,
the device comprises means for detecting a movement by the wearer to make a signature.

### DESCRIPTION OF THE FIGURES

The invention will be better understood while referring to the following description given by way of a non-limiting example, and to the appended drawings, wherein:

FIG. 1 shows a device for communicating through the body according to the invention;

FIG. 2 illustrates a module for communicating through the body according to the invention with examples of interfaces and/or connectors;

FIG. 3 illustrates a device for communicating through the body according to the invention supporting an accessory such as a display device;

FIG. 4 illustrates a device for communicating through the body according to the invention supporting a watch case;

FIG. 5 illustrates a flowchart of the steps of operation and/or use of the device of the invention.

### DETAILED DESCRIPTION OF THE INVENTION

Similar elements are designated by the same reference numbers throughout the Figures.

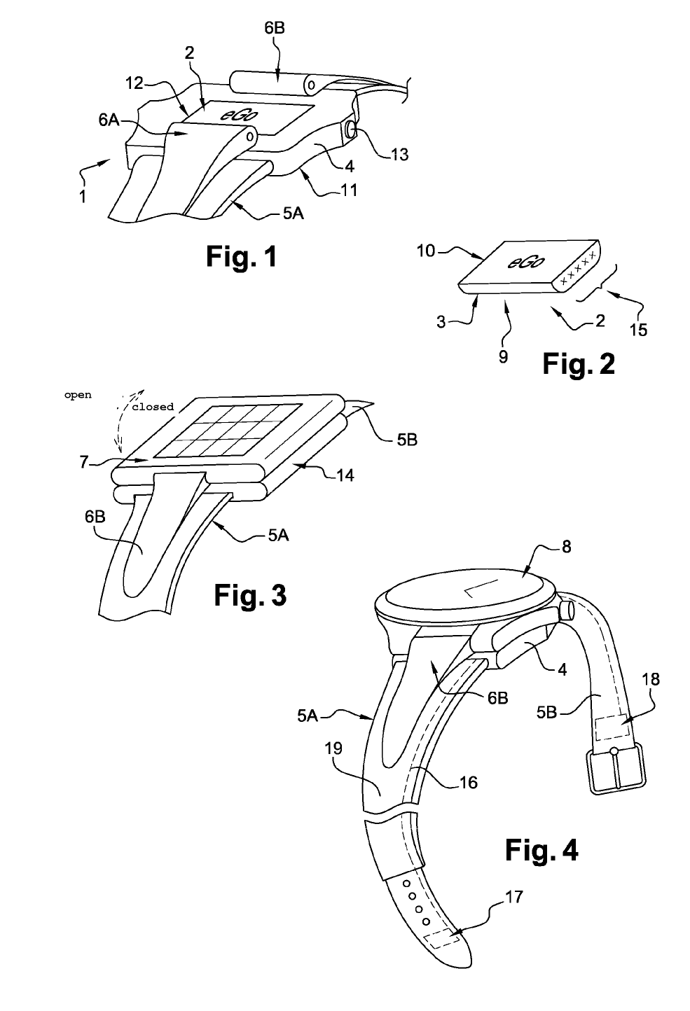

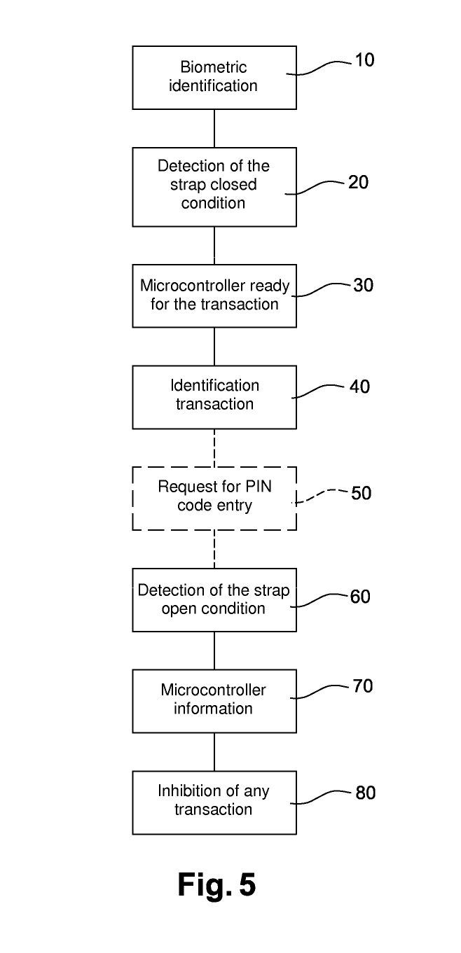

In FIG. 1, a portable electronic device according to one embodiment of the invention includes a module for communicating through the body (of the eGo-type) 2; the module comprises a contact surface 3 for electrically contacting the skin of a wearer;

Alternately, the surface may belong to a conductive portion of the device connected to the module;

The device also comprises a base 4 (or base housing) comprising the module 2; it also comprises means 5A, 5B for securing the device to a part of the body of the wearer, in contact with the skin;

It also comprises means 6A, 6B for attaching a personal accessory 7 or a watch case 8 to the device.

A module for communicating through the body of the eGo type is described in the patent EP 1695296 B1 and the essential characteristics thereof are integrated herein by reference.

A module according to the invention may include means of biometric identification such as a fingerprint sensor. It may also be connected to such a sensor located outside the module. Any other means of identification may be used such as speech recognition means, for instance.

The module includes means for electrically communicating through the body, more particularly of the capacitive type, with a user electric device. It preferably comprises means for storing identification data and/or password, which are secret, for giving access to the electric device.

The device or the module preferably further comprises means for storing the biometric data of the user. It preferably comprises processing means such as a microcontroller to implement forgery-proofing steps (such as a comparison, a cryptographic calculation, a validation and/or an authorization for an electronic transaction, the activation of an operation, a detection . . . ).

The module and/or the device may or may not include RF or NFC radio frequency communication means, such as a radio frequency chip, an antenna or an antenna connector.

A transaction may include any exchange of data to perform an operation (an access, a payment, a customisation, a forgery-proofing operation . . . ) of the type used in the field of smart cards.

The module may be permanently attached to the device and more particularly in the base thereof or be removable, or extractable. In the example, the module is designed as a removable micro housing 2 comprising a coating or casing, in particular made of plastic or metal with several connection or interface elements 15 enabling the operation thereof.

Among these elements, the module may include a biometric sensor 9 (not shown) on the underside of the module or alternately a connector for connecting a biometric sensor arranged elsewhere; it may include a power connector 10 to a battery contained by example in the base.

The base may include contacts or a connector 11 for the electric charging of the battery (not shown). The module may include a PC/touch screen interface.

According to other characteristics and alternate solutions, the means 6A, 6B for attaching an accessory or a watch may be positioned on the base 4 or on the securing means 5A, 5B, namely the strap;
according to a preferred embodiment, the securing means here comprises a strap 5A, 5B provided with watch case fasteners 6A, 6B arranged over the strap 5A, 5B;

The strap 5A, 5B may also include watch fasteners similar to those included in the fasteners 6A, 6B for attaching the base;

The base 4 comprises a housing 12 for receiving the communication module 2;
The receiving housing 12 is so configured as to removeably receive the module; removable fastening means of any type known to those skilled in the art may be provided in the housing for cooperating with complementary means arranged on the module such as notches, guides, a shoulder . . . ).

In FIG. 3, the device comprises as an accessory a sensitive display 7 having a square shape in top view. The display is supported by a base 14 of the type shown in FIG. 1.

The display and/or the accessory or the base may include a controller and/or various telecommunication and/or NFC functions. The display may include a preferably sensitive alphanumeric keypad, for an interaction with the user, in particular to enter a PIN and be possibly connected with the security module 2 and/or the base 14. Alternately, a picture of the user may be displayed on the screen of the display device for a visual access control.

One or more control keys 13 may be placed on the base.

In FIG. 4, the device 8 comprises a user's watch 8 as an accessory. The watch is discretely fixed to the base by means of watch fasteners 6A, 6B. As seen from above, the watch is visible for aesthetic purposes, whereas the base 4 is hidden.

The device may preferably include means for detecting securing to and separation from the wearer (not fully shown). These means may include, for example, a conductive circuit 16 extending from the base 4, 14 to the branches or sub-sections 5A, 5B of the strap and comprising capacitive plates 17, 18 at the ends thereof.

When the strap is in closed position, the capacitive plates are positioned opposite each other thereby closing the electric circuit 16. The device also comprises a circuit for detecting the closed condition of the strap which depends on the spacing of the capacitive plates. This circuit may be located in the base and may supply an input of the microcontroller with information.

The device is so configured as to perform a transaction after authentication and securing preferably within a predetermined time and/or before detecting a separation.

The device may include means for detecting a movement by the wearer to make a signature. Thus, when the wearer has been authenticated, the latter may validate a transaction by making a gesture or a series of gestures and/or accelerations in space with his/her arm or wrist as a virtual signature, which is detected by an integrated accelerometer and/or movement sensor.

This signature is compared to data stored in a memory of the device for validation. An enable signal, possibly enciphered or of the OTP type (single use), may then be sent by the device to a communication device via a communication through the skin.

The movement data may be transmitted in an enciphered form to the communication device while the user touches the screen with one hand and signs with the other hand. The device may decipher the movement data and compare the deciphered signature with the one stored in the device for validation, more particularly for giving access to the device or for a transaction in progress.

The invention has the advantage of enabling the user to sign, using the device, whereas the user is biometrically and discretely authenticated.

Although it has been described in connection with means of a removable type for attaching an accessory to the device, the invention may provide for a utilisation with a version without any accessory and without means for attaching the accessory or the watch case, for at least one of the other characteristics or functions shown in the description.

One utilisation and one operation are described hereinafter.

A user wishing to use a secure computer authenticates with the device (step 10). He/She places his/her finger on the fingerprint sensor 9 for recognition of the wearer; then he/she has a predetermined time to fix the base around his/her wrist and close the strap. When closing the strap, the capacities 17, 18 approach and this bringing together is detected by the detection circuit. The detection circuit informs the microcontroller (step 20). When the latter has been informed that the wearer has been authenticated within the time allowed, it is ready to work for the desired transactions (step 30). Authentication can include and implement additional or alternative speech recognition means.

The user touches a computer equipped with an authentication system for communicating through the body and an identification transaction takes place through the skin of the user (step 40).

The security system of the computer or of a session transaction on the Internet may provide, if need be, (optionally and in dotted lines in the Figure), a PIN entry by the user who enters his/her code into the sensitive display (step 50) using in particular the accessory 7. This code can reactivate the authentication of the wearer by the module and/or allow the online transmission of a transaction validation more particularly on a commercial site (step 60). This enables to validate a transaction discretely without having to put up an additional accessory during the transaction or each transaction (bank withdrawal from ATMs, access control . . . ).

Then, the user removes his/her strap, which causes the capacities 17, 18 to move away from each other; this state of separation is detected by the detection circuit which informs the microcontroller thereof (step 70).

Then the microcontroller disables or inhibits any transaction authorization by communicating through the body (step 80).

1. A portable electronic device comprising:
a module for communicating through the body, with said module comprising a contact surface for electrical contact with the skin of a wearer,
a base comprising said module,
means of securing the device to a part of the body of the wearer, in contact with the skin, and
means of attaching a personal accessory or a watch case arranged on the base or on said securing means.

2. A portable electronic device according to claim 1, wherein said securing means comprises a strap comprising fasteners for a watch case or a personal accessory arranged over the strap.

3. A portable electronic device according to claim 2, wherein the strap comprises watch fasteners to hold the base.

4. A portable electronic device according to claim 1, wherein the base comprises a housing for receiving the communication module.

5. A portable electronic device according to claim 4, wherein the receiving housing is so configured to removeably receive the module.

6. A portable electronic device according to claim 1, wherein the device further includes means for detecting securement to and separation from the wearer.

7. A portable electronic device according to claim 6, wherein the device comprises a detection circuit comprising capacitive plates.

8. A portable electronic device according to claim 7, wherein the device is configured to perform a transaction after authentication and securing within a predetermined time and/or before detecting a separation.

9. A portable electronic device according to claim 8, wherein the device comprises means for detecting a movement by the wearer to make a signature.
